(19) United States
(12) Patent Application Publication
(10) Pub. No.: US 2023/0039651 A1
(43) Pub. Date: Feb. 9, 2023

(54) MANAGEMENT ELECTRONIC DEVICE AND METHOD FOR WIRELESS COMMUNICATION, AND COMPUTER READABLE MEDIUM

(71) Applicant: Sony Group Corporation, Tokyo (JP)

(72) Inventors: Youping ZHAO, Beijing (CN); Cong LU, Beijing (CN); Chen SUN, Beijing (CN); Zhong TIAN, Beijing (CN)

(73) Assignee: Sony Group Corporation, Tokyo (JP)

(21) Appl. No.: 17/790,575

(22) PCT Filed: Jan. 4, 2021
(86) PCT No.: PCT/CN2021/070060

§ 371 Date: Jul. 1, 2022

(30) Foreign Application Priority Data
Jan. 9, 2020 (CN) 202010022118.X

(51) Int. Cl. H04W 16/10; H04W 12/106

(52) U.S. Cl. CPC H04W 16/10; H04W 12/106

(57) ABSTRACT

A management electronic device includes a processing circuit configured to: obtain a spectrum in an N-th round of spectrum trading and acquire the interference received by the management electronic device when an electronic device uses the traded spectrum; receive the interference received by another electronic device as determined by another electronic device related to spectrum trading; determine competition rights parameters of the management electronic device and the other electronic device, respectively, the competition rights parameters representing the credibility of the electronic devices and the magnitude of competitiveness when competing for management rights in an N+1-th round of spectrum trading; and select a new management electronic device on the basis of at least one among the interference and the competition rights parameters, the new management electronic device having management rights in the N+1-th round of spectrum trading, instead of the management electronic device having management rights.

This application claims the priority of Chinese Patent Application No. 202010022118.X, entitled “MANAGEMENT ELECTRONIC DEVICE AND METHOD FOR WIRELESS COMMUNICATION, AND COMPUTER READABLE MEDIUM”, filed with the China National Intellectual Property Administration on Jan. 9, 2020, the entire contents of which are incorporated herein by reference.

### FIELD

The present disclosure relates to the technical field of wireless communications, and particularly to processing related to spectrum transactions, and more particularly to a management electronic device and a method for wireless communications, an electronic device and a method for wireless communications, and a computer-readable medium.

### BACKGROUND

With the rapid development of wireless technology, available electromagnetic spectrums are becoming increasingly crowded. A series of reports and spectrum measurements show that some licensed spectrum (such as television broadcasting), is underutilized. In recent years, dynamic spectrum access (DSA) technology based on the cognitive radio has become a research hotspot, opening up a new way to improve spectrum utilization.

The dynamic spectrum access technology provides information transmission services for a secondary user (SU) by obtaining a spectral hole. That is, the secondary user is allowed to access a channel when a primary user (PU) does not use the channel, and the secondary user must give up the channel when the primary user reoccupies the channel. The way that the secondary user “opportunistically” accesses an idle channel can greatly improve the spectrum utilization and reduce the waste of spectrum. Therefore, the dynamic spectrum access technology will be the core technology to solve spectrum allocation for the next generation mobile communication.

Therefore, a spectrum management system for managing spectrum transactions is a current research focus.

However, with the rapid development of 5G commercialization, the Internet of Things, the Internet of Vehicles, and artificial intelligence, the number of wireless access points increases exponentially. The increase in the wireless access points brings various challenges to the current wireless resource management, such as higher spectrum requirements, complex interference management, lower allocation efficiency, and security of user data.

### SUMMARY

A brief summary of the present invention is given below, to provide a basic understanding of some aspects of the present invention. It should be understood that the following summary is not an exhaustive summary of the present invention. It does not intend to determine a key or important part of the present invention, nor does it intend to limit the scope of the present invention. Its object is only to present some concepts in a simplified form, which serves as a preamble of a more detailed description to be discussed later.

According to an aspect of the present disclosure, a management electronic device for wireless communications is provided. The management electronic device has a management right in an Nth round of spectrum transactions, where N is a positive integer greater than or equal to 1. The management electronic device includes a processing circuit, configured to: obtain an interference suffered by the management electronic device when a spectrum acquiring electronic device in the Nth round of spectrum transactions use a transacted spectrum; receive interference suffered by other electronic device when the spectrum acquiring electronic device use the transacted spectrum, which is determined by the other electronic device related to spectrum transactions; determine competition right parameters of the management electronic device and the other electronic device respectively, where the competition right parameter characterizes a degree of trust and competitiveness for competing a management right in an (N+1)th round of spectrum transactions of the electronic device; and select a new management electronic device based on at least one of the interference and the competition right parameters, where the new management electronic device rather than the management electronic device has the management right in the (N+1)th round of spectrum transactions.

According to an aspect of the present disclosure, a base station for wireless communications is provided. The base station includes the management electronic device.

According to an aspect of the present disclosure, an electronic device for wireless communications is provided. The electronic device includes a processing circuit configured to: send an interference, which is suffered by the electronic device when a spectrum acquiring electronic device in an Nth round of spectrum transactions use a transacted spectrum, to a management electronic device that has a management right in the Nth round of spectrum transactions, where N is a positive integer greater than or equal to 1; and receive, from the management electronic device, information on a new management electronic device that has a management right in an (N+1)th round of spectrum transactions.

According to an aspect of the present disclosure, a base station for wireless communications is provided. The base station includes the electronic device.

According to an aspect of the present disclosure, a method for wireless communications is provided. The method includes: obtaining an interference suffered by a management electronic device when a spectrum acquiring electronic device in an Nth round of spectrum transactions uses a transacted spectrum, where the management electronic device has a management right in the Nth round of spectrum transactions, and N is a positive integer greater than or equal to 1; receiving an interference suffered by other electronic device when the spectrum acquiring electronic device use the transacted spectrum, which is determined by the other electronic device related to spectrum transactions; determining competition right parameters of the management electronic device and the other electronic device respectively, wherein the competition right parameters characterize a degree of trust and competitiveness for competing a management right in an (N+1)th round of spectrum transactions of the electronic device; and selecting a new management electronic device based on at least one of the interference and the competition right parameters, where the new management electronic device rather than the management electronic device has the management right in the (N+1)th round of spectrum transactions.

According to an aspect of the present disclosure, a method for wireless communications is provided. The method includes: sending an interference, which is suffered by an electronic device when a spectrum acquiring electronic device in an Nth round of spectrum transactions uses a transacted spectrum, to a management electronic device that has a management right in the Nth round of spectrum transactions, where N is a positive integer greater than or equal to 1; and receiving, from the management electronic device, information on a new management electronic device that has a management right in an (N+1)th round of spectrum transactions.

According to other aspects of the present invention, there are further provided a computer program code and a computer program product for implementing the above-mentioned methods for wireless communications, as well as a computer-readable storage medium on which the computer program code for implementing the above-mentioned methods for wireless communications is recorded.

These and other advantages of the present invention will be more apparent through the following detailed description of preferred embodiments of the present invention in conjunction with the accompanying drawings.

### BRIEF DESCRIPTION OF THE DRAWINGS

In order to further set forth the above and other advantages and features of the present invention, specific embodiments of the present invention will be further described in detail below in conjunction with the accompanying drawings. The accompanying drawings together with the following detailed description are included in this specification and form a part of this specification. Elements with identical functions and structures are denoted by identical reference numerals. It should be understood that, the drawings only describe typical examples of the present invention, and should not be regarded as limitations to the scope of the present invention. In the accompanying drawings:

FIG. 1 shows a block diagram of functional modules of a management electronic device for wireless communications according to an embodiment of the present disclosure:

FIG. 2 is a diagram showing an example of a blockchain-based spectrum management system according to an embodiment of the present disclosure;

FIG. 3 shows an example information flow between a node with a billing right of a block N when selecting a node with a billing right of a block N+1 and other node in the blockchain-based spectrum management system according to an embodiment of the present disclosure;

FIG. 4 shows an example of a protection area according to an embodiment of the present disclosure;

FIG. 5 shows an example in which an accumulated interference suffered by a node is obtained by calculation according to an embodiment of the present disclosure;

FIG. 6 shows an example in which an accumulated interference suffered by a node is obtained by measurement according to an embodiment of the present disclosure:

FIG. 7 shows an example of a structure of a block according to an embodiment of the present disclosure;

FIG. 8 is a diagram illustrating a simulation scenario of a spectrum management system according to an embodiment of the present disclosure:

FIG. 9 shows parameter settings of the simulation scenario of the spectrum management system according to an embodiment of the present disclosure:

FIG. 10 shows an example of a competition right parameter of each node in the spectrum management system according to an embodiment of the present disclosure;

FIG. 11 shows an example of an interference suffered by each node in the spectrum management system according to an embodiment of the present disclosure:

FIG. 12 shows an example of the number of spectrum coins of each node in the case of selecting the node with the billing right of the block N+1 according to an embodiment of the present disclosure and by adopting a proof-of-stake mechanism;

FIG. 13 shows an example of a final satisfaction degree of each node in the case of selecting the node with the billing right of the block N+1 according to an embodiment of the present disclosure and by adopting the proof-of-stake mechanism;

FIG. 14 shows a block diagram of functional modules of an electronic device for wireless communications according to an embodiment of the present disclosure;

FIG. 15 shows a flowchart of a method for wireless communications according to an embodiment of the present disclosure;

FIG. 16 shows a flowchart of a method for wireless communications according to another embodiment of the present disclosure:

FIG. 17 is a block diagram showing a first example of a schematic configuration of an eNB or gNB to which the technology of the present disclosure can be applied;

FIG. 18 is a block diagram showing a second example of a schematic configuration of an eNB or gNB to which the technology of the present disclosure can be applied; and

FIG. 19 is a block diagram of an exemplary structure of a universal personal computer by which the methods and/or devices and/or systems according to the embodiments of the present invention can be implemented.

### DETAILED DESCRIPTION

Hereinafter, illustrative embodiments of the present disclosure are described in conjunction with the accompanying drawings. For the sake of clarity and conciseness, the description does not describe all features of actual embodiments. However, it should be understood that in developing any such actual embodiment, many decisions specific to the embodiments must be made, so as to achieve specific objects of a developer; for example, those limitation conditions related to systems and services are satisfied, and these limitation conditions possibly vary with embodiments. In addition, it should also be appreciated that, although developing work may be very complicated and time-consuming, such developing work is only routine tasks for those skilled in the art benefiting from the present disclosure.

It should also be noted herein that, to avoid the present invention from being obscured due to unnecessary details, only those device structures and/or processing steps closely related to the solution according to the present invention are shown in the accompanying drawings, while omitting other details less related to the present invention.

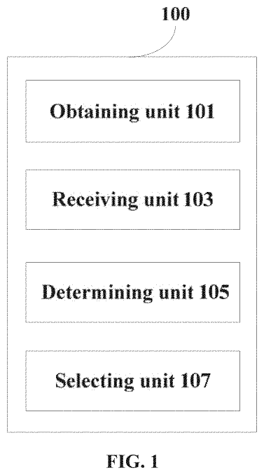

FIG. 1 shows a block diagram of functional modules of a management electronic device 100 for wireless communications according to an embodiment of the present disclosure. The management electronic device 100 has a management right in an Nth round of spectrum transactions, where N is a positive integer greater than or equal to 1. As shown in FIG. 1, the management electronic device 100 includes an obtaining unit 101, a receiving unit 103, a determining unit 105 and a selecting unit 107. The obtaining unit 101 is configured to obtain an interference suffered by the management electronic device when a spectrum acquiring electronic device in the Nth round of spectrum transactions use a transacted spectrum. The receiving unit 103 is configured to receive interference suffered by other electronic devices when the spectrum acquiring electronic devices use the transacted spectrum, where the interference is determined by the other electronic devices related to spectrum transactions. The determining unit 105 is configured to determine competition right parameters of the management electronic device and the other electronic devices respectively, where the competition right parameters characterize a degree of trust and competitiveness for competing a management right in an (N+1)th round of spectrum transactions of the electronic device. The selecting unit 107 is configured to select a new management electronic device based on at least one of the interference and the competition right parameters, where the new management electronic device rather than the management electronic device has the management right in the (N+1)th round of spectrum transactions.

The obtaining unit 101, the receiving unit 103, the determining unit 105 and the selecting unit 107 each may be implemented by one or more processing circuits, and the processing circuits may be implemented as a chip, for example.

The management electronic device 100 may be arranged on base station side or communicably connected to a base station. For example, the management electronic device 100 may function as a base station, and may further include external devices such as a memory and a transceiver (not shown). The memory can be configured to store related data information and programs executed by the base station to implement various functions. The transceiver may include one or more communication interfaces to support communication with various devices (for example, user equipment or another base station), and the implementation form of the transceiver is not specifically limited here.

For example, the spectrum acquiring electronic device may be a management electronic device, and may also be included in another electronic device. Spectrum transactions involve transfer of ownership of a spectrum. The use of the transacted spectrum by the spectrum acquiring electronic device in the Nth round of spectrum transactions may cause harmful interference to an electronic device other than the spectrum acquiring electronic device. For example, each of the management electronic device 100 and other electronic devices may be interfered (with a unit of dBm) by one or more spectrum acquiring electronic devices in the Nth round of spectrum transactions. Therefore, hereinafter, this interference is sometimes referred to as accumulated interference. Each of the management electronic device and the other electronic devices obtains its own received interference, and each of the other electronic devices sends its received interference to the management electronic device. When the management electronic device 100 is the spectrum acquiring electronic device in the Nth round of spectrum transactions, the accumulated interference does not include the interference of the management electronic device 100 to itself, that is, the interference of the management electronic device 100 to itself is zero.

For example, the new management electronic device may be the above-described management electronic device, or may be other electronic device than the above-described management electronic device. For example, the new management electronic device may be an electronic device among the above-mentioned other electronic devices, for example, the new management electronic device may be a spectrum acquiring electronic device.

The management electronic device 100 according to the embodiment of the present disclosure selects the new management electronic device based on at least one of the accumulated interference suffered by the electronic device and the competition right parameter of the electronic device, so that the new management electronic device can be efficiently determined, the fairness for the electronic device competes to become the new management electronic device can be improved, and the satisfaction degree of the electronic device can be improved.

The obtaining unit 101 is configured to calculate, if it is determined that the spectrum acquiring electronic device is located in a protection area of the management electronic device 100, the interference to the management electronic device 100 when the spectrum acquiring electronic device uses the transacted spectrum. The protection area is determined based on spectrum transaction information related to the Nth round of spectrum transactions.

In order to reduce the calculation amount when the management electronic device 100 calculates the accumulated interference and thus reduce the system overhead, a “protection area” is defined for the management electronic device 100. The interference of the spectrum acquiring electronic device located in the protection area to the management electronic equipment 100 is calculated in the accumulated interference, and the interference of the spectrum acquiring electronic device not located in the protection area to the management electronic device 100 is ignored (that is, the interference from a spectrum acquiring electronic device far enough from the management electronic device 100 is negligible).

A size of the protection area is affected by various factors. For example, the protection area is determined based on spectrum transaction information related to the Nth round of spectrum transactions. More specifically, the size of the protection area may be calculated based on information (for example, location and transmission power, and so on) of the spectrum acquiring electronic device in the spectrum transaction information related to the Nth round of spectrum transactions.

For example, the protection area may be a circular area centered on the management electronic device 100. A radius of the circular area is calculated based on transmission power of the spectrum acquiring electronic device and/or a spectrum providing electronic device included in the spectrum transaction information as well as a predetermined interference threshold set for the management electronic device 100.

It is assumed that the total number of spectrum acquiring electronic devices and spectrum providing electronic devices included in the Nth round of transactions is M. The transmission powers of the M electronic devices are respectively P₁, P₂ . . . P_{M}, and a maximum transmission power is Pₘₐₓ=max(P₁, P₂ . . . P_{M}). The predetermined interference threshold set for the management electronic device 100 is denoted as Iₜₕ. Therefore, the radius R of the protection area is calculated from equation (1).

$$R = \frac{λ}{4 π} \cdot \sqrt[n]{\frac{{P}_{max} \cdot {G}_{Tx} \cdot {G}_{Rx}}{{I}_{th}}} \qquad ( 1 )$$

In equation (1). G_{Tx} represents a transmit gain of an electronic device with a maximum transmission power Pₘₐₓ, G_{Rx} represents a receive gain of the management electronic device 100, a is a path loss coefficient, and k is a spectral wavelength.

Those skilled in the art may also think of other methods for calculating the radius of the protection area, which are not described herein. In addition, those skilled in the art should understand that the protection area may be an area other than a circular area, which is not described herein.

In the embodiment according to the present disclosure, the accumulated interference suffered by the management electronic device 100 is calculated based on the protection area, thereby reducing the number of spectrum providing electronic devices that interfere with the management electronic device 100 involved in the calculation of the accumulated interference. Therefore, the calculation amount of the management electronic device 100 is reduced, thereby reducing the system overhead.

For example, the obtaining unit 101 may be configured to calculate the interference based on location information of the spectrum acquiring electronic device, location information of the management electronic device 100 and transmission power information of the spectrum acquiring electronic device.

It is assumed that among the spectrum acquiring electronic devices in the Nth round of spectrum transactions, Nₜᵣₛ spectrum acquiring electronic devices are located in the protection area of the management electronic device 100. The interference I suffered by the management electronic device 100 when the spectrum acquiring electronic device in the Nth round of spectrum transactions uses the transacted spectrum may be calculated from the following equation (2).

$$I = {\sum }_{k = 1}^{{N}_{trs}} {I}_{k} = {\sum }_{k = 1}^{{N}_{trs}} [ {P}_{Tx}^{k} \cdot {G}_{Tx}^{k} \cdot {G}_{Rx} \cdot {( \frac{λ}{4 π {d}_{k}} )}^{{α}_{k}} ] \qquad ( 2 )$$

In equation (2), P_{Tx}^{k} is a transmission power of a kth spectrum acquiring electronic device 100 located in the protection area of the management electronic device 100. G_{Tx}^{k} is a transmit gain of the kth spectrum acquiring electronic device located in the protection area of the management electronic device 100. G_{Rx} represents a receive gain of the management electronic device 100. dₖ is a distance between the management electronic device 100 and the kth spectrum acquiring electronic device located in the protection area of the management electronic device 100. αₖ is a path loss coefficient between the management electronic device 100 and the kth spectrum acquiring electronic device located in the protection area of the management electronic device 100, and λ is a spectral wavelength, where k=1, 2, . . . , Nₜᵣₛ.

As can be seen from the above description, the management electronic device 100 can accurately obtain the accumulated interference by calculation.

The management electronic equipment 100 is not only interfered by the spectrum acquiring electronic device included in the Nth round of transactions, but also interfered by other electronic devices and user equipment (end user) within a coverage area of each electronic device. In order to obtain the accumulated interference suffered by the management electronic device 100 more comprehensively, the obtaining unit 101 may also obtain the accumulated interference by measurement.

For example, the obtaining unit 101 may be configured to neither provide services for the user equipment within the coverage area of the management electronic device 100 nor receive a signal from the user equipment for a predetermined period of time, and determine a received signal measured within the predetermined period of time as interference.

For example, the obtaining unit 101 sets a predetermined period of time (hereinafter sometimes referred to as a silent time period) Tᵢ⁰. During this period of time, the channel of the management electronic device 100 is closed (that is, stops transmitting), and the management electronic device 100 provides no service to its user equipment. The user equipment of the management electronic device 100 also stops sending information, the management electronic device 100 fails to receive the information (that is, a useful signal) sent by the user equipment. In this way, a Gaussian white noise (noise floor) channel is obtained. The obtaining unit 101 only receives an interference signal during this period of time. The total power of the received signals is the accumulated interference I received by the management electronic device 100.

It is assumed that the total number of interference sources in the measurement is N_{IS}, the accumulated interference I′ suffered by the management electronic device 100 may be expressed as;

$${I}^{′} = {\sum }_{i = 1}^{{N}_{IS}} {I}_{i} \qquad ( 3 )$$

In equation (3), Iₜ is interference of each interference source to the management electronic device 100, where k=1, 2, . . . , N_{IS}.

For example, the management electronic device 100 may set the “silent time” by itself.

The I′ obtained by the management electronic device 100 by means of measurement can more comprehensively reflect the accumulated interference suffered by the management electronic device 100.

For example, the determining unit 105 may be configured to, for each of the management electronic device 100 and the other electronic devices, calculate the competition right parameter of the electronic device based on at least one of the total amount of spectrum held by the electronic device, a total time period that the electronic device held the spectrum, the total amount of currency held by the electronic device to acquire the spectrum, and the time period that the electronic device held the currency. As the total amount of spectrum held by the electronic device is greater and/or the total amount of time period that the electronic device holds the spectrum is longer, the competition right parameter of the electronic device is greater, and as the total amount of currency held by the electronic device is greater and/or the time period that the electronic device holds the currency is longer, the competition right parameter of the electronic device is greater.

For example, as the total amount of spectrum held by the electronic device is greater and/or the spectrum is held by the electronic device is longer, the cost for the electronic device to “lie” is larger, and therefore the credibility is higher and the competition right parameter is higher. Conversely, the competition right parameter of the electronic device is lower. Furthermore, as the total amount of currency held by the electronic device is greater and/or the electronic device holds the currency is longer, the cost for the electronic device to “lie” is larger, and therefore the credibility is higher and the competition right parameter is higher. Conversely, the competition right parameter of the node is lower.

For example, it is assumed that a sum of the number of the management electronic device 100 and the number of other electronic devices is N_{mode}. εᵢ represents the competition right parameter of each electronic device, and ranges from 0 to 1, where i=1, 2, . . . , N_{mode}. Nₛₚ represents the total amount of spectrum held by an electronic device. tₛₚ represents a total time period that the electronic device holds the spectrum. N_{co} represents the total amount of currency held by the electronic device. t_{co} represents a time period that the electronic device holds the currency. If the competition right parameter of the electronic device is calculated based on the total amount of spectrum held by the electronic device, the total time period that the electronic device holds the spectrum, the total amount of currency held by the electronic device for acquiring the spectrum and the time period that the electronic device holds the currency. εᵢ can be expressed as:

εᵢ=f(Nₛₚ,tₛₚ,N_{co},t_{co}) (4)

In equation (4), f( ) represents a function.

In an example, equation (4) may be embodied as equation (5).

$${ε}_{i} = \frac{{w}_{1} \cdot ( {N}_{co} \cdot {t}_{co} ) + {w}_{2} \cdot ( {N}_{sp} \cdot {t}_{sp} )}{{ε}_{max}} \qquad ( 5 )$$

In equation (5), w₁ and w₂ each represent a weight, which may be set according to actual needs. εₘₐₓ is a maximum among w₁·(N_{co}·t_{co})+w₂·(Nₛₚ·tₛₚ) of the management electronic device 100 and other electronic devices.

The management electronic device 100 calculates the competition right parameter of the electronic device, thereby ensuring the fairness and security of the competition management right, and ensuring the stake of a credible electronic device.

In an example, the selecting unit 107 may be configured to select the new management electronic device based only on the interference. For example, the selecting unit 107 may be configured to determine an electronic device having a greatest interference among the management electronic device 100 and other electronic devices as the electronic device having the competition right. The management electronic device 100 selects the electronic device that suffers the most interference as the new management electronic device, so as to improve the performance (for example, signal-to-interference-to-noise ratio SINR) and a satisfaction degree of the electronic device. Those skilled in the art can think of other examples in which the selecting unit 107 selects the new management electronic device based on interference, which are not described herein.

In an example, the selecting unit 107 may be configured to select the new management electronic device based only on the competition right parameter. For example, the selecting unit 107 may be configured to determine an electronic device having the largest competition right parameter among the management electronic device 100 and other electronic devices as the electronic device having the competition right. The management electronic device 100 selects the electronic device with the largest competition right parameter as the new management electronic device, so as to ensure the fairness of the competition. Those skilled in the art can think of other examples in which the selecting unit 107 selects the new management electronic device based on the competition right parameter, which are not described herein.

In an example, the selecting unit 107 may select the new management electronic device based on both the interference and the competition rights parameters.

In an example, the selecting unit 107 may be configured to determine an electronic device having a competition right parameter greater than a predetermined competition right parameter threshold among the management electronic device 100 and other electronic devices as the electronic device having the competition right, and select, in the presence of at least one second electronic device that is more interfered compared to a first electronic device among the electronic devices with the competition right and a difference between the interferences between the at least one second electronic device is less than a predetermined difference threshold, the electronic device with the largest competition right parameter among the at least one second electronic device as the new management electronic device.

The predetermined competition weight parameter threshold is represented as εₜₕ. A set including the management electronic device 100 and other electronic devices is represented as Met, and then a set N^{ε} of electronic devices with the competition right may be obtained from the following equation (6).

N^{ε}=Nset(ε≥εₜₕ) (6)

In an example, an electronic device in the set Nset rather than in the set N^{ε} does not have the competition right since its competition right parameter is smaller than the predetermined competition right parameter threshold.

In an example, the selecting unit 107 may compare the accumulated interference of the electronic devices in the set N of electronic devices having the competition right, and determine an electronic device with the largest accumulated interference as the new management electronic device. In an example, if there is at least one second electronic device, in the set N^{ε} of the electronic devices with the competition right, whose accumulated interference close to each other (that is, a difference between the accumulated interference is smaller than a predetermined difference threshold) and the accumulated interference each is greater than the accumulated interference of other electronic device (the first electronic device) in the set N^{ε} of electronic devices with the competition right, the competition rights parameter of the at least one second electronic device is compared, and an electronic device with the largest competition right parameter is selected as the new management electronic device. Those skilled in the art may determine the predetermined difference threshold based on experience. Those skilled in the art may think of other examples in which the selecting unit 107 selects the new management electronic device based on both the interference and the competition right parameter, which are not described herein.

The management electronic device 100 selects the new management electronic device from the electronic devices with the competition right, thereby ensuring the security and reliability for competing the management right, and further reducing the system overhead required for competing the management right. The management electronic device 100 selects the electronic device that suffers from relatively large accumulated interference as the new management electronic device, which can improve the (eg, the signal-to-interference-to-noise ratio SINR) and the satisfaction degree of the electronic device.

In an example, the selecting unit 107 may be configured to notify other electronic devices of a result of selecting the new management electronic device, and send the interference suffered by the management electronic device 100 and the interference suffered by other electronic devices to the new management electronic device. The new management electronic device records the interference suffered by the management electronic device 100 and the interference suffered by other electronic devices in spectrum transaction information about the (N+1)th round of spectrum transactions.

The interference information recorded in the spectrum transaction information may be used to analyze a change in the performance (such as interference, and SINR) of different electronic devices and determine the interference relationship between different electronic devices, so as to provide corresponding information for improving system performance.

In an example, the management electronic device 100 and other electronic devices serve as a subject of a decentralized spectrum management system, and the management right is included in the billing right in the decentralized spectrum management system.

In an example, the decentralized spectrum management system includes a blockchain.

The embodiments of the present disclosure provide a combination of blockchain and dynamic spectrum access technology. The blockchain-based spectrum management system is an example of the decentralized spectrum management system. Anode in a blockchain-based spectrum management system is an example of the subject. The spectrum transactions in the block N serves as an example of the Nth round of spectrum transactions. A spectrum coin is an example of a currency. In the following embodiments related to the blockchain-based spectrum management, for the convenience of description, the spectrum transactions are sometimes referred to as transactions, and the management electronic device 100 is sometimes referred to as the node with the billing right of the block N, the spectrum acquiring electronic device is sometimes referred to as a buyer node, the spectrum providing electronic device is sometimes referred to as a seller node, and the management electronic device, the electronic device, the spectrum acquiring electronic device, and the spectrum providing electronic device each are referred to as a node for short.

In conventional technology, the method for determining the billing right in the blockchain system usually includes Proof of work (PoW) mechanism. Proof of stake (PoS) mechanism and Delegated proof of stake (DPoS) mechanism. However, these mechanisms have some problems and shortcomings. For example, powerful computing power of the PoW mechanism may cause waste of resources (such as electricity), and the PoW mechanism is relatively unsuitable for commercial applications of small transactions due to its transaction confirmation time period of up to 10 minutes. PoS and DPoS mechanisms may result in centralization.

With reference to the above description of the management electronic device 100, it can be seen that the blockchain-based spectrum management system according to the embodiment of the present disclosure can more efficiently and fairly determine the node that has the billing right of the block.

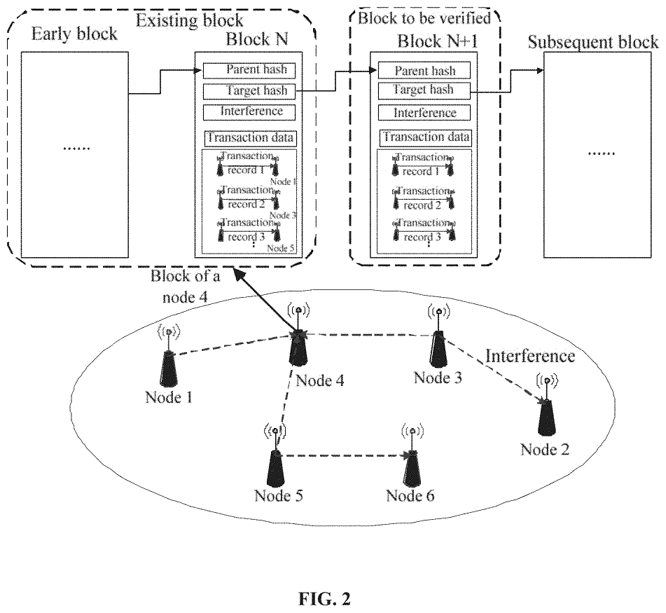

FIG. 2 is a diagram illustrating an example of a blockchain-based spectrum management system according to an embodiment of the present disclosure.

The blockchain-based spectrum management system includes multiple coexisting nodes, such as a node 1, a node 2, a node 3, a node 4, a node 5 and a node 6. When two nodes in the system reach the willingness to transact a spectrum, transaction information is broadcasted to all nodes in the system. Therefore, each node in the system can receive information about all pending transactions (that is, information about transactions to be verified). Each node collects all unverified transactions in the system, and saves the transaction information in its own block to form a new block, which records information about all upcoming spectrum transactions that have occurred within a recent period of time. However, only a block constructed by a node with the billing right is connected, after passing verification of the coexisting nodes in the system, to a main blockchain and stored locally by each node. In addition, the node with the billing rights is rewarded with virtual currency (spectrum coin) issued by the system.

The spectrum coin is virtual currency for purchasing spectrum. The node may obtain the billing right of the block through competition, to obtain the spectrum coin issued by the system. Alternatively, the node transacts the spectrum or legal currency with another node, to obtain the spectrum coin. The generation (that is, connection to the main blockchain) of each block is accompanied by issuance of spectrum coin. The issuance mechanism of the spectrum coin may refer to the issuance mechanism of Bitcoin. At the beginning, 50 spectrum coins are issued for every block generated, and the spectrum coin reward generated with the block is halved every 210,000 blocks. When a node fails to obtain the spectrum coin through the billing right, the reward for motivating the node to continue billing becomes the handling fee paid by other node, so that the system continues to operate.

In FIG. 2, it is assumed that the current block is a block N. For example, in FIG. 2, it is assumed that the block constructed by the node 4 is the block N, that is, the node 4 has the billing right of the block N. The block N constructed by the node 4 is connected to the main blockchain after being verified by other nodes. A block before the block N is marked as an early block. The block N and the early block have been verified and connected to the main blockchain. Each node in the system stores the verified block N and the early block locally. The transactions stored in these blocks have already occurred. In FIG. 2, the early block and the block N each are referred to as an existing block.

The information about the spectrum transactions is stored in the block in the form of a list. For example, a transaction record 1, a transaction record 2, and a transaction record 3 in the block N record the information about the spectrum transactions. For example, the buyer node in the transaction record 1 is the node 1, the buyer node in the transaction record 2 is the node 3, and the buyer node in the transaction record 3 is the node 5. The buyer node of transactions that have already taken place saved in the block N may interfere with other nodes when using the transacted spectrum. For example, in FIG. 2, the node 1, the node 3, and the node 5 as buyer nodes stored in the block N may interfere with other nodes. For example, the node 1 may interfere with the node 4, the node 3 may interfere with the node 2 and the node 4, and the node 5 may interfere with the node 4 and the node 6.

The block to be verified is denoted as a block N+1. In the present disclosure, the node that has the billing right of the block N (for example, the node 4 in FIG. 2) selects a node that has the billing right of the block N+1, that is, selects a node. A block constructed by the selected node is connected to the main blockchain after being verified by other nodes, and the selected node is rewarded with virtual currency (spectrum coins) issued by the system. In FIG. 2, a block after the block N+1 is marked as a subsequent block.

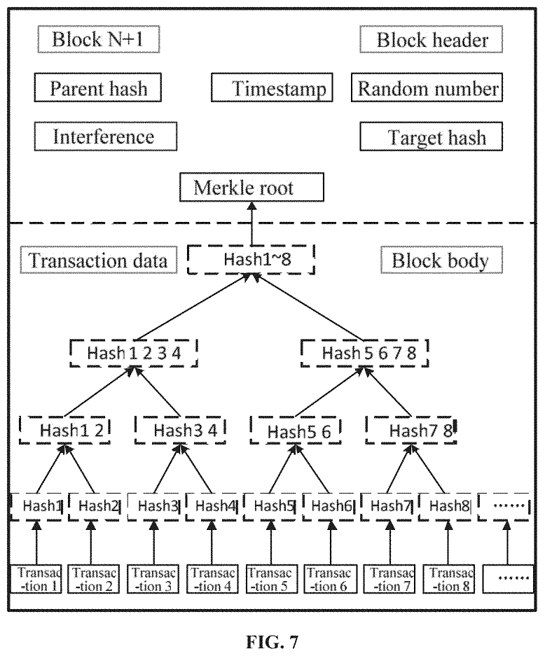

It should be noted that the structures of the block N and the block N+1 shown in FIG. 2 will be described below with reference to FIG. 7, and are not described in detail here.

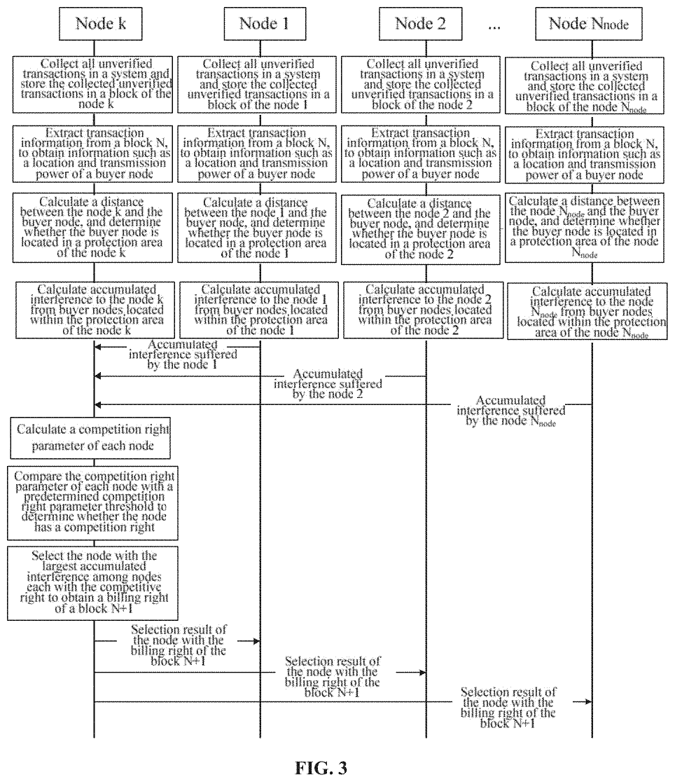

FIG. 3 shows an example information flow between the node with the billing right of the block N when selecting the node with the billing right of the block N+1 and other node in the blockchain-based spectrum management system according to an embodiment of the present disclosure.

The total number of coexisting nodes in the blockchain-based spectrum management system is N_{node}, that is, there are a node 1, a node 2, . . . , a node N_{node} in the system. The node with the billing right of the block N+1 is selected from these coexisting nodes. For the convenience of description, it is assumed that a node k in the coexisting nodes has the billing right of the block N. In the example of FIG. 3, the node k is a node other than the node 1, the node 2, and the node N_{node} among the coexisting nodes.

First, each node in the system collects all unverified transactions in the system and stores the transaction information in its own block. As shown in FIG. 3, the node k stores all unverified transaction information in the system in the block of the node k, the node 1 stores all unverified transaction information in the system in the block of the node 1, and so on.

Each node in the system may extract each transaction information from the block N, and obtains information such as a location and a transmission power of the buyer node of the transaction information.

Each node in the system may calculate a distance between the node and the buyer node based on position information of the buyer node extracted for the transaction, and determine whether the buyer node is located in the protection area of the node. Only the interference of the buyer node located in the protection area may be calculated in the accumulated interference suffered by the node, and the interference of a buyer node located outside the protection area is ignored. In the following, description is made by taking the protection area of each node as a circle. It should be understood by those skilled in the art that the protection area may be an area other than a circle. In addition, it should be noted that the radius of the protection area of each node may be the same or different. In the case where the radius of the protection area is the same for each node, the radius may be calculated from equation (1). The radius of the protection area of each node is the same, which can reduce the system overhead and improve the system efficiency. It should be understood by those skilled in the art that the accumulated interference to each node by all buyer nodes in the transaction recorded in the block N is calculated, rather than only the accumulated interference caused by the buyer nodes located within the protection area of the node.

Each node may be interfered by multiple buyer nodes, and each buyer node may interfere with multiple nodes. For a buyer node located in the protection area of a node, the accumulated interference suffered by the node is calculated based on the distance between each node and the buyer node and the transmission power of the buyer node.

Anode other than the node k sends the calculated interference to the node k.

The node k calculates a competition right parameter of each node. For example, the node k may calculate the competition right parameter for each node from equation (4) and/or equation (5).

The node k may select the node having the billing right of the block N+1 based on at least one of the accumulated interference and competition right parameter. FIG. 3 shows that the node k selects the node that has the billing right of the block N+1 based on both the accumulated interference and the competition right parameter. For example, the node k may compare the competition right parameter of each node with a predetermined competition right parameter threshold to determine whether the node has the competition right. A node whose competition right parameter is smaller than the predetermined competition right parameter threshold does not have the competition right of the billing right the block N+1, otherwise the node has the competition right of the billing right the block N+1. For the nodes having the competition right, the node k compares the accumulated interference of each node. In an example, the node that suffers the most accumulated disturbance will obtain the billing right of the block N+1. If there is at least one nodes having approximate and larger accumulated interference, the competition right parameter of the at least one nodes is compared, and the node with the largest competition right parameter obtains the billing right of the block N+1. In an example, if difference between the accumulated interference suffered by anode p, anode q, and a node r is less than a predetermined difference threshold, that is, the accumulated interferences of the nodes p, q, and r are approximately equal, and are larger among all nodes, the node with the largest competition right parameter among the nodes p, q, and r is selected to obtain the billing right of the block N+1.

Finally, the node k sends the selection result of the node with the billing right of the block N+1 (that is, the new management electronic device as mentioned above) to all other nodes, and sends the accumulated interference information of each node to the selected node with the billing right of the block N+1.

The information flow in FIG. 3 shows that each node obtains the accumulated interference to the node from the buyer nodes located in the block N within its protection area by calculation.

Alternatively, as described above, each node may determine the accumulated interference suffered by the node through measurement. In an example, each node is provided with a silent time period. During this time period, the channel of the node is closed (that is, stops transmitting), no service is provided to its user equipment, its user equipment also stops sending information, and the node fails to receive information (i.e., a useful signal) sent by its user equipment. In this way, a Gaussian white noise (noise floor) channel is obtained, the node only receives the interference signal, and the total power of the received signal is the accumulated interference suffered by the node.

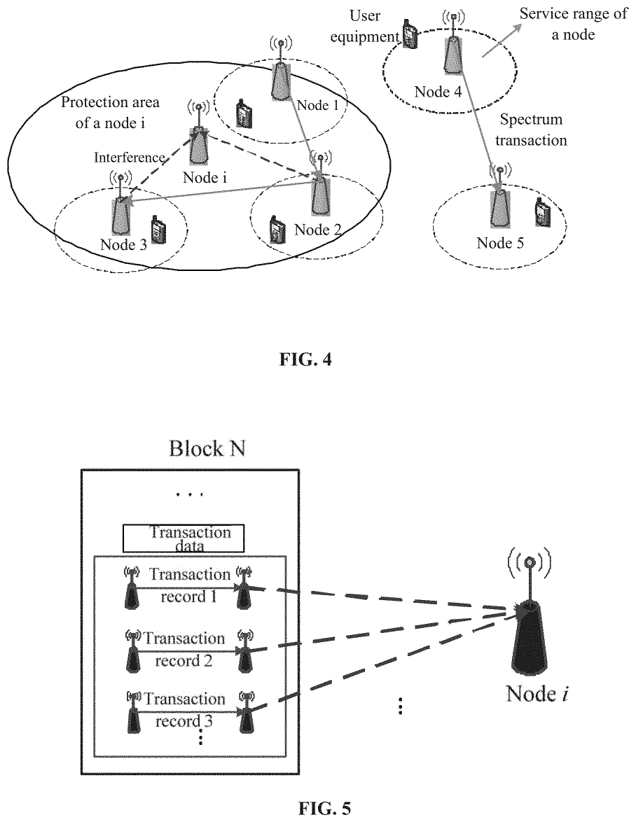

FIG. 4 shows an example of the protection area according to an embodiment of the present disclosure.

It is assumed that three transactions that have occurred are stored in the block N, namely, the transaction between the node 1 and the node 2, the transaction between the node 2 and the node 3, and the transaction between the node 4 and the node 5. In FIG. 4, an ellipse drawn with a solid line represents the protection area of the node i (where i=6, 7, . . . , N_{node}), and an ellipse drawn with a dotted line represents a service range of each node. As shown in FIG. 4, the buyer node 2 of the transaction between the node 1 and the node 2, and the buyer node 3 of the transaction between the node 2 and the node 3 are located in the protection area of the node i, and the buyer node 5 of the transaction between the node 4 and the node 5 is not located within the protection area of the node i. Therefore, the accumulated interference Iᵢ suffered by the node i only includes the interference from the node 2 and the node 3, that is, Iᵢ=Iᵢ²+Iᵢ³. Iᵢ² and Iᵢ³ represent the interference of the node 2 and the node 3 to the node i, respectively.

In the case that the protection area of each node is a circular area and radii of the protection areas are equal, the radius of each protection area is calculated from equation (1).

In a decentralized spectrum management system (for example, a blockchain), there is no trusted third-party agency to guarantee the credibility of each node. A node newly accessing the system has low credibility. If this node directly participates in the competition for the billing right without being verified for its credibility, resulting in failure to guarantee the security of the system and a reduction in the fairness of the system. As described above, in the embodiments according to the present disclosure, it is determined based on the competition right parameter whether each node has the competition right for the billing right of the block N+1. The competition right parameter εᵢ of each node may be calculated from the above equations (4) and (5). Therefore, the fairness and security of the system are guaranteed.

FIG. 5 shows an example in which an accumulated interference suffered by a node is obtained by calculation according to an embodiment of the present disclosure. As mentioned above, the buyer node of a transaction stored in the block N may interfere with other nodes. As shown in FIG. 5, a node i may be interfered by a buyer node of a transaction record 1, a buyer node of a transaction record 2, and a buyer node of a transaction record 3 that are stored in transaction data of the block N. The node i extracts the transaction data in the block N, calculates a distance between the node i and the buyer node of the transaction record 1, a distance between the node i and the buyer node of the transaction record 2, and a distance between the node i and the buyer node of the transaction record 3, and determines whether respective buyer nodes of these transaction records are located in the protection area of the node i. The accumulated interference suffered by the node i from a buyer node located within the protection area of the node i may be calculated from equation (2).

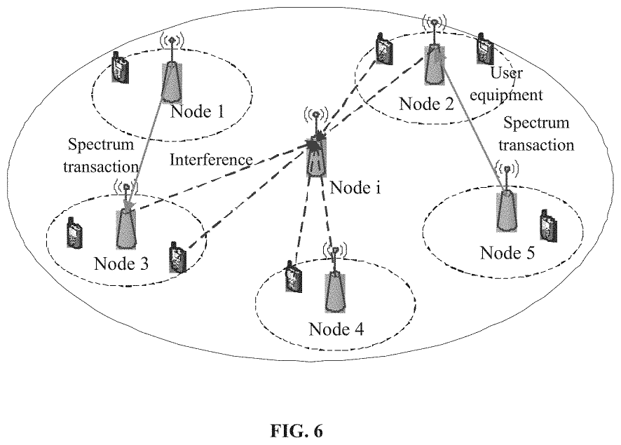

FIG. 6 shows an example in which an accumulated interference suffered by a node is obtained by measurement according to an embodiment of the present disclosure. Each node in the system is not only interfered by the buyer node of the transaction stored in the block N, but also interfered by other nodes and the user equipment of the node. It is assumed that the block N stores two transactions, namely, a transaction between a node 1 and a node 3 (where the buyer node is the node 3), and a transaction between the node 2 and the node 5 (where the buyer node is the node 2). As shown in FIG. 6, the node i is not only interfered by the buyer nodes (including the node 2 and the node 3) of the transactions stored in the block N, but also interfered by other nodes (such as the node 4), and further interfered by user equipment of the node 2, the node 3 and the node 4. The accumulated interference suffered by the node i may be determined by measurement. In an example, the node i selects a “silent time period” Tᵢ⁰. During the time period Tᵢ⁰, the channel of the node i is closed (that is, stops transmitting). The node i do not provide services to its user equipment, and does not receive signals sent by its user equipment, that is, does not receive valid signals. The node i receives the interference information in the time period Tᵢ⁰, and obtains the interference power which is the accumulated interference suffered by the node i. When the time period Tᵢ⁰ elapses, the node i resumes receiving valid signals and sends the accumulated interference information to the node k.

FIG. 7 shows an example of a structure of a block according to an embodiment of the present disclosure. In FIG. 7, a block N+1 serves as an example for description. As shown in FIG. 7, a block includes a block header (Header) and a block body (Body). Although not all shown in FIG. 7, the block header may encapsulate information such as a current version number, a hash value of a previous block (that is, a parent hash), a target hash value of the current block, a random number of the current block, a Merkle root, and a timestamp. The block body includes data of transactions in block N+1. In an example, the transaction data to be verified in the block body may be hashed in groups. As shown in FIG. 7, the Hash 1 to Hash 8 of transactions 1 to 8 are hashed in groups. The generated new Hash 1 2, Hash 3 4, Hash 5 6, Hash 7 8 are inserted into the Merkle tree, and then Hash 1 2 3 4 and Hash 5 6 7 8 are recursively generated until the last root Hash 1˜8 is obtained. The root Hash 1˜8 is recorded as the Merkle root in the block header. Finally, the Merkle root is encapsulated into the block header. Since a change of any transaction data may result in a change of the Merkle root, existence and integrity of the block data can be quickly summarized and verified.

In an example, the new management electronic device records the interference suffered by the management electronic device 100 and the interference suffered by other electronic devices in the block header of the block including spectrum transaction information of the (N+1)th round of spectrum transactions.

In an example, the node with the billing right of block N+1 records the interference suffered by the node with the billing right of the block N and the interference suffered by other nodes among the coexisting nodes in a block header of the block N+1. That is to say, as shown in FIG. 7, the “interference” information is included in the block header of the block N+1.

A block structure in the traditional blockchain does not include interference information. In the embodiments according to the present disclosure, the node that obtains the billing right is rewarded with spectrum coins issued by the system. The node that obtains spectrum coins tends to obtain more spectrum to improve the performance of the node and the user. Therefore, the interference information in the block may be utilized to record a issuance record (that is, an issuance track) of the spectrum coins, which is convenient for other node to trace billing history of a previous node to prevent an inappropriate node (for example, a node whose accumulated interference is not the largest) from obtaining the billing right. Further, the interference information may be utilized to analyze a change in the performance (such as interference and SINR) of a node and determine the interference relationship between nodes, so as to provide corresponding information for improving the system performance.

An application scenario of the spectrum management system according to the embodiment of the present disclosure is briefly described below. Each of the coexisting nodes involved in the spectrum management system may be a base station. These nodes may be all nodes in a residential area, or all nodes in a city. These nodes may belong to the same operator or may belong to different operators. In an example, transactions may take place between any two nodes, that is to say, transactions are not restricted by geographic regions. Alternatively, in a case that a distance between two nodes exceeds a predetermined range, the two nodes cannot conduct transactions. In an example, a radius of the coverage area of a node is R_{node}, and a radius of a predetermined action range is Rₘₐₓ=x·R_{mode} (where x is a number greater than 0). If a distance d between two nodes is greater than Rₘₐₓ, the two nodes cannot conduct transactions, otherwise the two nodes can conduct transactions. A value of Rₘₐₓ may be preset by the system. Spectrum coins may be utilized for spectrum transactions between nodes. The spectrum management system may be a blockchain-based spectrum management system. There is no trusted third-party organization in the system to verify an identity of each node, conduct billing and the like. Each block is recorded by a node to the main blockchain, and is recorded by one node with the billing right. A node that obtains the billing right of the block from competition is rewarded with spectrum coins issued by the system.

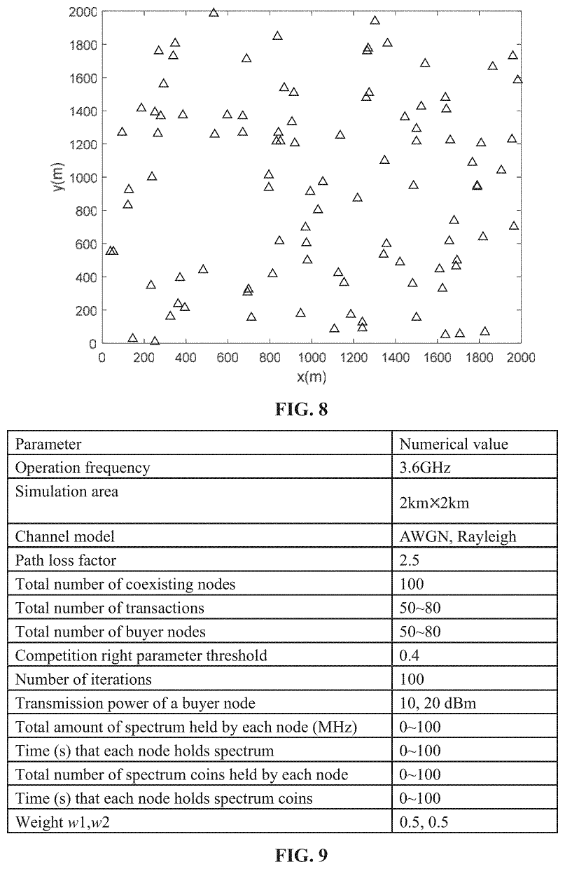

FIG. 8 is a diagram illustrating a simulation scenario of the spectrum management system according to an embodiment of the present disclosure, where x and y represent geographic coordinates of a node in the system. FIG. 9 shows parameter settings of the simulation scenario of the spectrum management system according to an embodiment of the present disclosure.

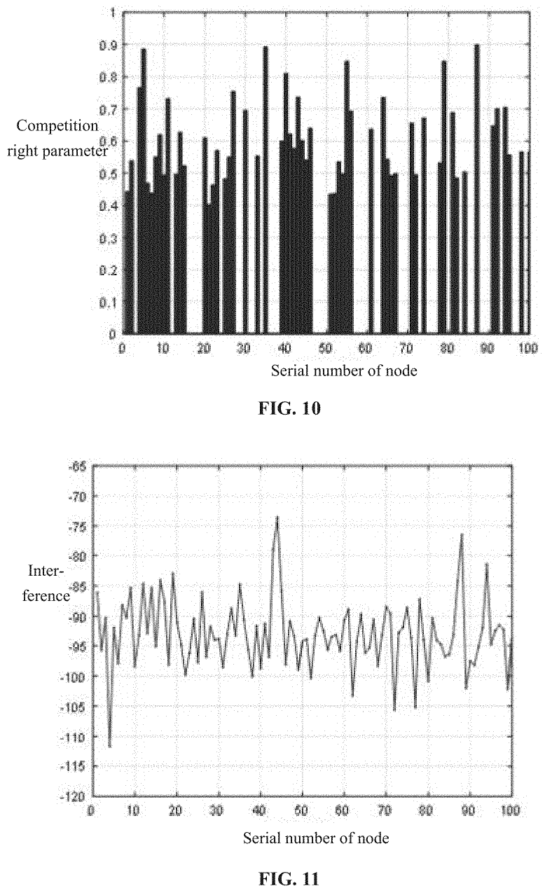

Triangles in FIG. 8 represent nodes in the spectrum management system. These nodes each may be a base station and are randomly distributed. In FIG. 8, it is assumed that there are 100 nodes in total, and the ownership of the billing right of the block N+1 is to be determined from these nodes. The total number of spectrums owned by each node is between 0 and 100 MHz. The number of spectrum coins owned by each node is between 0 and 100. The total time period that each node owns the spectrum coins and the spectrums is between 0 and 100 seconds. The weights w₁ and w₂ in equation (5) are 0.5 each, and the predetermined competition right parameter threshold is 0.4. Those skilled in the art should understand that the above parameters may be determined empirically. The competition right parameter of each node is calculated from equation (5). FIG. 10 shows an example of a competition right parameter of each node in the spectrum management system according to an embodiment of the present disclosure. The competition right parameter of each node is compared with the predetermined competition right parameter threshold. A node whose competition right parameter is lower than the predetermined competition right parameter threshold does not have the competition right for the billing right of the block N+1. A node whose competition right parameter is higher than the predetermined competition right parameter threshold has the competition right for the billing right of the block N+1.

The interference (accumulated interference) suffered by each node may be calculated from equation (2). FIG. 11 shows an example of an interference suffered by each node in the spectrum management system according to an embodiment of the present disclosure. In an example, the node that has the billing right of the block N may select the node that receives the most accumulated interference among the coexisting nodes that have the billing right, as the node that has the billing right of the block N+1.

In an example, each node having the billing right is rewarded with 50 spectrum coins issued by the system.

The essence of the proof-of-stake (PoS) mechanism in the conventional technology is that a node with the highest stake in the system obtains the billing right of the block N+1. The stake is reflected in ownership of a node for a certain number of coins, and in called coin age or coin days. The coin age is a product of a certain number of coins and a length of time period of their last transaction, and each transaction consumes a certain amount of coin age. For example, after a node receives 10 coins in a transaction and owns the 10 coins for 10 days, the node obtains 100 coin ages. After the node spends 5 coins, 50 coin ages are consumed. It is apparent that the total amount of coin age at a certain point in certain time for a system based on the PoS mechanism is limited, and a node owns the coins for a long time period tend to have more coin age. Therefore, the coin age may be regarded as the stake of the node in the PoS system. The node with the highest coin age obtains the billing right of the block N+1, and is rewarded with 50 spectrum coins issued by the system.

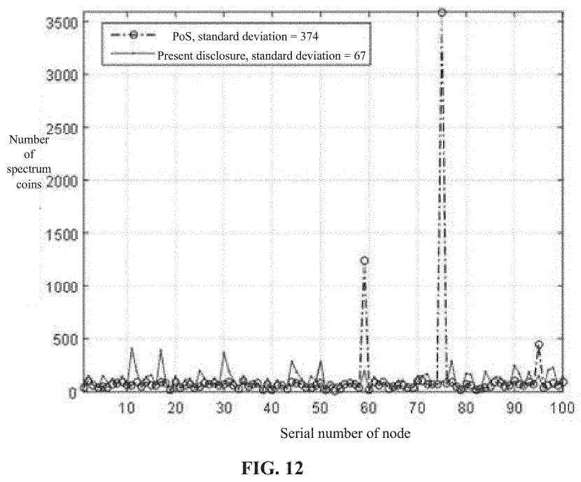

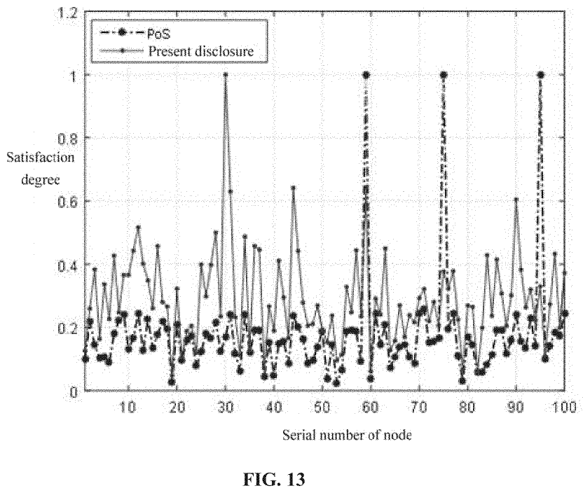

In an example, in the mechanism of selecting the node with the billing right of block N+1 in the embodiments of the present disclosure, the node with the billing right of the block N+1 is determined based on the competition right parameter and accumulated interference. Since the probability of interference suffered by each node is similar, the probability of each node obtaining the billing right and being rewarded with spectrum coins is also similar. Therefore, the expected distribution of spectrum coins after 100 iterations based on the mechanism according to the embodiments of the present disclosure is more even. The parameter settings of the simulation scenario of the spectrum management system are shown in FIG. 9, and a comparison curve of distribution of the spectrum coins after 100 iterations is shown in FIG. 12, which shows an example of the number of spectrum coins of each node in the case of selecting the node with the billing right of the block N+1 according to an embodiment of the present disclosure and by adopting a proof-of-stake mechanism.

As can be seen from FIG. 12, in the process of determining the billing right of the block N+1 based on the PoS mechanism, a node with an larger coin age is more likely to obtain the billing right of the block and to be reward with spectrum coins issued by the system. Therefore, spectrum coins are easy to concentrate on a few nodes. However, in the embodiments of the present disclosure, the spectrum coins for each node are distributed evenly. This difference may be explained by a standard deviation of the distribution of spectrum coins. For the PoS mechanism, the standard deviation of the distribution of spectrum coins is 374. In the embodiments of the present disclosure, the standard deviation of the distribution of spectrum coins is 67. Therefore, the embodiments of the present disclosure can improve the fairness of the system.

It is assumed that the total amount of spectrum owned by each node is obtained through spectrum transactions, and the spectrum coins owned by the node are obtained through competition to obtain the billing right. The satisfaction degree of each node is defined as δᵢ=Nₛₚⁱ/Dₛₚⁱ, where Nₛₚⁱ is the total amount of spectrum owned by each node, and Dₛₚⁱ is the total demand for spectrum by each node. The satisfaction degree of each node obtained after 100 iterations serves as the final satisfaction degree of the node. FIG. 13 shows an example of a final satisfaction degree of each node in the case of selecting the node with the billing right of the block N+1 according to an embodiment of the present disclosure and by adopting the proof-of-stake mechanism. It can be seen from FIG. 13 that, the satisfaction degree of the vast majority of nodes based on the mechanism according to the embodiment of the present disclosure is greater than that of the nodes based on the proof-of-stake mechanism. That is, in a case that the node with the billing right of the block N+1 is selected according to the embodiment of the present disclosure, the satisfaction degree of the node can be significantly improved, and the fairness of the system can be improved.

A base station for wireless communications is further provided according to the present disclosure. The base station includes the management electronic device 100.

Although the above description is given with the management electronic device 100 as a base station as an example, those skilled in the art should understand that the management electronic device 100 may be user equipment.

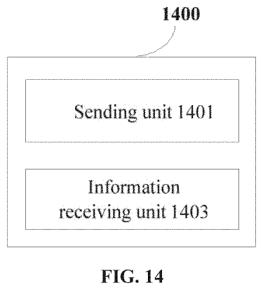

An electronic device for wireless communications is further provided according to the present disclosure. FIG. 14 shows a block diagram of functional modules of an electronic device 1400 for wireless communications according to an embodiment of the present disclosure. As shown in FIG. 14, the electronic device 1400 includes a sending unit 1401 and an information receiving unit 1403. The sending unit 1401 is configured to send an interference suffered by the electronic device 1400 when a spectrum acquiring electronic device in an Nth round of spectrum transactions uses a transacted spectrum to a management electronic device that has a management right in the Nth round of spectrum transactions, where N is a positive integer greater than or equal to 1. The information receiving unit 1403 is configured to receive, from the management electronic device, information on a new management electronic device that has a management right in an (N+1)th round of spectrum transactions.

The sending unit 1401 and the information receiving unit 1403 each may be implemented by one or more processing circuits, and the one or more processing circuits may be implemented as a chip, for example.

The electronic device 1400 may be arranged, for example, at a base station side or communicatively connected to a base station. For example, the electronic device 1400 may function as the base station itself, and may further include external devices such as a memory and a transceiver (not shown). The memory may be configured to store programs and related data information for the base station to implement various functions. The transceiver may include one or more communication interfaces to support communications with different devices (for example, user equipment and another base station), and the implementation of the transceiver is not limited herein.

Spectrum transactions involve transfer of ownership of a spectrum. The spectrum acquiring electronic device in the Nth round of spectrum trading when using the traded spectrum may cause harmful interference to an electronic device other than the spectrum acquiring electronic device. In an example, the electronic device 1400 may be interfered by one or more spectrum acquiring electronic devices in the Nth round of spectrum transactions. Therefore, this interference is sometimes referred to as accumulated interference hereinafter. The electronic device 1400 obtains the interference suffered by itself, and sends the interference suffered by the electronic device 1400 to the management electronic device having the management right in the Nth round of spectrum transactions.

The management electronic device 100 described above is an example of the management electronic device having the management right in the Nth round of spectrum transactions. It can be known from the above description of the management electronic device 100 that the management electronic device 100 is configured to select a new management electronic device that has the management right in the (N+1)th round of spectrum transactions. The information receiving unit 1403 receives from the management electronic device 100 the information about the new management electronic device having the management right in the (N+1)th round of spectrum transactions.

In order to reduce the calculation amount when the electronic device 1400 calculates the accumulated interference and thus reduce the system overhead, a “protection area” is defined for the electronic device 1400. The interference from a spectrum acquiring electronic device located within the protection area to the electronic device 1400 is counted in the accumulated interference. The interference from a spectrum acquiring electronic device not located within the protection area is negligible (that is, interference from the spectrum acquiring electronic device that is sufficiently far away from the electronic device 1400 is negligible).

In an example, the sending unit 1401 is configured to calculate, when it is determined that the spectrum acquiring electronic device is located within the protection area of the electronic device 1400, the interference to the electronic device 1400 when the spectrum acquiring electronic device uses the transacted spectrum. The protection area is determined based on spectrum transaction information related to the Nth round of spectrum transactions.

A size of the protection area may be influenced by a number of factors. In an example, the protection area is determined based on spectrum transaction information related to the Nth round of spectrum transactions. More specifically, the size of the protection area may be calculated based on information (for example, location and transmission power) of the spectrum acquiring electronic device in the spectrum transaction information related to the Nth round of spectrum transactions.

For example, the protection area may be a circular area centered on the electronic device 1400. A radius of the circular area is calculated based on transmission power of the spectrum acquiring electronic device and/or a spectrum providing electronic device included in the spectrum transaction information as well as a predetermined interference threshold set for the electronic device 1400.

For the protection area of the electronic device 1400, reference may be made to the description of equation (1) and FIG. 4 in the embodiment of the management electronic device 10x), and only the parameters related to the management electronic device 100 are replaced with the corresponding parameters of the electronic device 1400. Details are not repeated here.

In the embodiment according to the present disclosure, the accumulated interference suffered by the electronic device 1400 is calculated based on the protection area, reducing the number of spectrum providing electronic devices that interfere with the electronic device 1400 involved in the calculation of the accumulated interference, and thus reducing the calculation amount of the electronic device 1400, thereby reducing the system overhead.

In an example, the sending unit 1401 is configured to calculate the interference based on the position information of the spectrum acquiring electronic device, the position information of the electronic device 1400, and the transmission power information of the spectrum acquiring electronic device.

For the calculation of the interference suffered by the electronic device 1400, reference may be made to the method for obtaining the accumulated interference by calculation in the embodiment of the management electronic device 100, and the description about equation (2) and FIG. 5. The parameters of the management electronic device 100 may be replaced with the parameters of the electronic device 1400, and details are not repeated here. In a case that the electronic device 1400 is the spectrum acquiring electronic device in the Nth round of spectrum transactions, the accumulated interference does not consider the interference of the electronic device 1400 to itself, that is, the interference of the electronic device 1400 to itself is zero.

In an example, the sending unit 1401 is configured not to provide services for the user equipment within the coverage of the electronic device 1400 or receive signals from the user equipment for a predetermined period of time, and determine received signals measured within the predetermined period of time as interference.

For the method for the electronic device 1400 to obtain the interference by measurement, reference may be made to the method for obtaining the accumulated interference by measurement in the embodiment of the management electronic device 100, and the description about equation (3) and FIG. 6. The parameters related to the management electronic device 100 may be replaced with the corresponding parameters of the electronic device 1400, and details are not repeated here.

In an example, the electronic device 1400 and the management electronic device each are a subject of a decentralized spectrum management system, and the management right is included in the billing right in the decentralized spectrum management system.

In an example, the decentralized spectrum management system includes a blockchain.

In an example, the electronic device 1400 may be any node among the coexisting nodes in FIG. 2 rather than the node having the billing right of the block N.

In an example, the electronic device 1400 may be a node other than the node k among the coexisting nodes in FIG. 3. For example, the electronic device 1400 may be one of the Node 1, the Node 2, and the Node N_{node}. For the information interaction between the electronic device 1400 and the management electronic device, reference is made to the description about FIG. 3 in the embodiment of the management electronic device 100, and details are not repeated here.

A base station for wireless communications is further provided according to the present disclosure. The base station includes the electronic device 1400.

The electronic device 1400 as the base station serves as an example in the above description. However, those skilled in the art should understand that the electronic device 1400 may be user equipment.

In the process of describing the management electronic device for wireless communication and the electronic device for wireless communication in the above embodiments, it is apparent that some processing or methods are also disclosed. A summary of these methods is given below without repeating some of the details already discussed above. It should be noted, however, that although the methods are disclosed in the description of the management electronic device for wireless communications and the electronic device for wireless communications, the methods do not necessarily employ or be performed by those components described. For example, implementations of the management electronic device for wireless communications and the electronic device for wireless communications may be implemented in part or entirely in hardware and/or firmware. These methods for wireless communications discussed below may be implemented entirely by computer executable programs, although these methods may also employ hardware and/or firmware of the management electronic device for wireless communications and the electronic device for wireless communications.

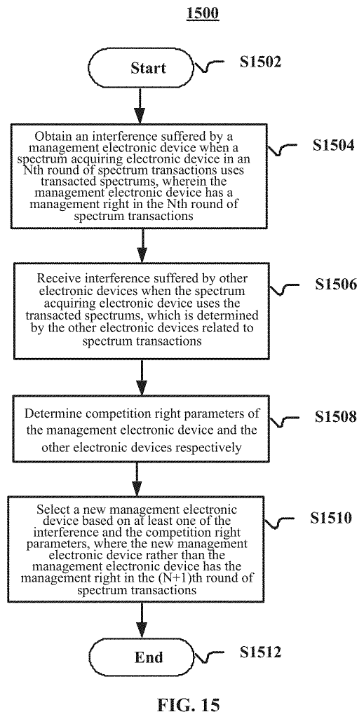

FIG. 15 shows a flowchart of a method 1500 for wireless communications according to one embodiment of the present disclosure. The method 1500 begins at step S1502. In step S1504, the interference suffered by a management electronic device when a spectrum acquiring electronic device in an Nth round of spectrum transactions uses a transacted spectrum is obtained. The management electronic device has a management right in the Nth round of spectrum transactions, where N is a positive integer greater than or equal to 1. In step S1506, interference suffered by other electronic devices when the spectrum acquiring electronic device uses the transacted spectrum is received, wherein the interference is determined by the other electronic devices related to the spectrum transactions. In step S1508, the competition right parameters of the management electronic device and the other electronic devices are determined respectively. The competition right parameter characterizes the reliability of the electronic device and its competitiveness when competing for the management right in the (N+1)th round of spectrum transactions. In step S1510, a new management electronic device is selected based on at least one of interference and the contention right parameter. In the (N+1)th round of spectrum transactions, the new management electronic device has the management right instead of the management electronic device. The method 1500 ends at step S1512. The method 1500 may be performed at the base station side, for example.

This method may be performed by, for example, the management electronic device 100, and the details thereof may be found in the description above, and are not repeated here.

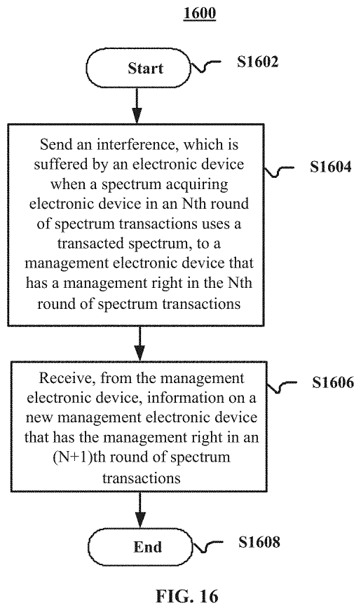

FIG. 16 shows a flowchart of a method 1600 for wireless communications according to another embodiment of the present disclosure. The method 1600 begins at step S1602. In step S1604, the interference suffered by the electronic device when a spectrum acquiring electronic device in an Nth round of spectrum transactions uses the transacted spectrum is sent to a management electronic device having a management right in the Nth round of spectrum transactions. N is a positive integer greater than or equal to 1. In step S1606, information on a new management electronic device having the management right in an (N+1)th round of spectrum transactions is received from the management electronic device. The method 1600 ends at step S1608. The method 1600 may be performed at the base station side.

The method 1600 may be performed by, for example, the electronic device 1400, and the details thereof may be found in the description above, and are not repeated here.

It should be noted that the above methods may be utilized in combination or individually.

The technology of the present disclosure may be applied to various products.

For example, the management electronic device 100 and the electronic device 1400 each may be implemented as various base stations. The base station may be implemented as any type of evolved Node B (eNB) or gNB (5G base station). The eNB includes, for example, a macro eNB and a small eNB. The small eNB may be an eNB covering a cell smaller than a macro cell, such as a pico eNB, a micro eNB, and a home (femto) eNB. The gNB is similar to the eNB. Instead, the base station may be implemented as any other type of base station, such as a NodeB and a base transceiver station (BTS). A base station may include: a subject (also referred to as a base station equipment) configured to control wireless communications; and one or more remote radio heads (RRHs) arranged at a different location from the subject. In addition, various types of user equipment may operate as a base station by temporarily or semi-persistently performing function of a base station.

### Application Examples About Base Station

### First Application Example

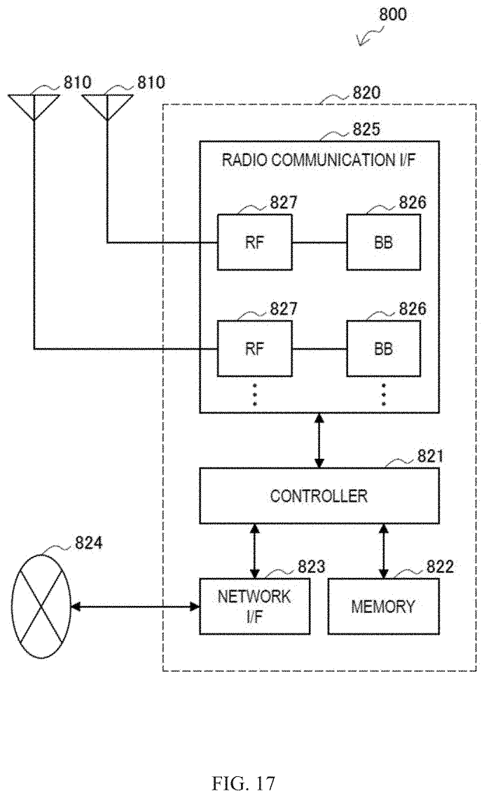

FIG. 17 is a block diagram illustrating a first example of a schematic configuration of an eNB or gNB to which the technology of the present disclosure may be applied. Note that the following description takes an eNB as an example, and the same may be applied to a gNB. An eNB 800 includes one or more antennas 810 and a base station equipment 820. Each antenna 810 may be connected to the base station equipment 820 via an RF cable.

Each of the antennas 810 includes a single element or multiple antenna elements (such as multiple antenna elements included in a multiple-input multiple-output (MIMO) antenna), and is used for the base station equipment 820 to transmit and receive wireless signals. As shown in FIG. 17, the eNB 800 may include multiple antennas 810. For example, the multiple antennas 810 may be compatible with multiple frequency bands used by the eNB 800. Although FIG. 17 shows an example in which the eNB 800 includes multiple antennas 810, the eNB 800 may include a single antenna 810.

The base station equipment 820 includes a controller 821, a memory 822, a network interface (I/F) 823, and a radio communication interface 825.

The controller 821 may be, for example, a CPU or a DSP, and operates various functions of a higher layer of the base station equipment 820. For example, the controller 821 generates a data packet from data in the signal processed by the radio communication interface 825 and transmits the generated packet via the network interface 823. The controller 821 may bundle data from multiple baseband processors to generate a bundled packet, and transmit the generated bundled packet. The controller 821 may have logical functions to perform controls such as radio resource control, radio bearer control, mobility management, admission control and scheduling. This control may be performed in conjunction with a nearby eNB or a core network node. The memory 822 includes a RAM and a ROM, and stores programs executed by the controller 821 and various types of control data such as a terminal list, transmission power data, and scheduling data.

The network interface 823 is a communication interface for connecting the base station equipment 820 to a core network 824. The controller 821 may communicate with the core network node or another eNB via the network interface 823. In this case, the eNB 800 and the core network node or other eNBs may be connected to each other through a logical interface (such as an S1 interface and an X2 interface). The network interface 823 may also be a wired communication interface, or a radio communication interface for a wireless backhaul line. If the network interface 823 is a radio communication interface, the network interface 823 may use a higher frequency band for wireless communications than the frequency band used by the radio communication interface 825.

The radio communication interface 825 supports any cellular communication scheme (such as Long-Term Evolution (LTE) and LTE-Advanced), and provides wireless connection to a terminal located in a cell of the eNB 800 via an antenna 810. The radio communication interface 825 may generally include, for example, a baseband (BB) processor 826 and an RF circuit 827. The BB processor 826 may execute, for example, encoding/decoding, modulation/demodulation, and multiplexing/demultiplexing, and execute various types of signal processing of layers (e.g., L1, Medium Access Control (MAC), Radio Link Control (RLC), and Packet Data Convergence Protocol (PDCP)). Instead of the controller 821, the BB processor 826 may have a part or all of the above-mentioned logical functions. The BB processor 826 may be a memory storing a communication control program, or a module including a processor and related circuits configured to execute the program. An update program may cause the function of the BB processor 826 to be changed. The module may be a card or blade inserted into a slot of the base station equipment 820. Alternatively, the module may also be a chip mounted on a card or blade. Meanwhile, the RF circuit 827 may include, for example, a mixer, a filter, and an amplifier, and transmit and receive a wireless signal via the antenna 810.

As shown in FIG. 17, the radio communication interface 825 may include multiple BB processors 826. For example, the multiple BB processors 826 may be compatible with multiple frequency bands used by the eNB 800. As shown in FIG. 17, the radio communication interface 825 may include multiple RF circuits 827. For example, the multiple RF circuits 827 may be compatible with multiple antenna elements. Although FIG. 17 shows an example in which the radio communication interface 825 includes multiple BB processors 826 and multiple RF circuits 827, the radio communication interface 825 may also include a single BB processor 826 or a single RF circuit 827.

In the eNB 800 as shown in FIG. 17, the transceiver of the management electronic device 100 may be implemented by the radio communication interface 825. At least a part of the function may also be implemented by the controller 821. For example, the controller 821 may select a new management electronic device by performing the functions of the obtaining unit 101, the receiving unit 103, the determining unit 105, and the selecting unit 107.

Furthermore, in the eNB 800 shown in FIG. 17, the transceiver of the electronic device 1400 may be implemented by the radio communication interface 825. At least a part of the function may also be implemented by the controller 821. For example, the controller 821 may transmit the interference suffered by the electronic device 1400 to the management electronic device and receive information on the new management electronic device by performing the functions of the transmitting unit 1401 and the information receiving unit 1403.

### Second Application Example

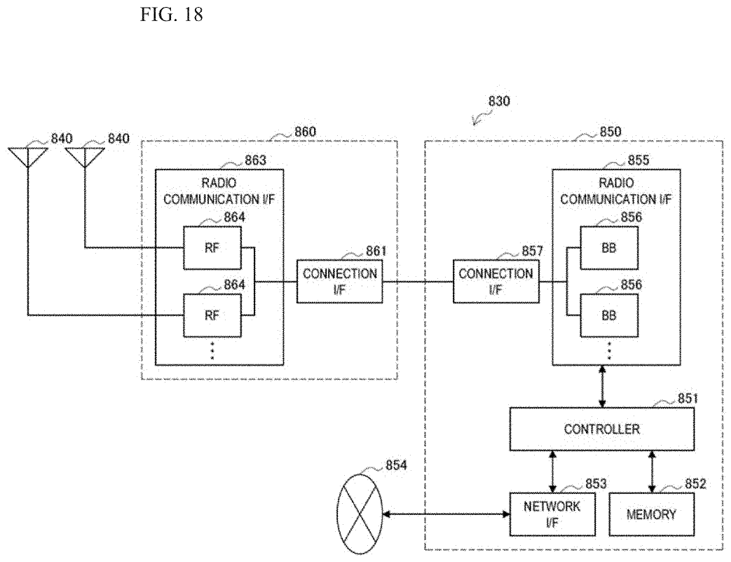

FIG. 18 is a block diagram showing a second example of a schematic configuration of an eNB or gNB to which the technology of the present disclosure can be applied. Note that similarly, the following description takes an eNB as an example, but it may also be applied to a gNB. An eNB 830 includes one or more antennas 840, base station equipment 850, and an RRH 860. Each antenna 840 may be connected to the RRH 860 via an RF cable. The base station equipment 850 may be connected to the RRH 860 via a high-speed line such as an optical fiber cable.

Each of the antennas 840 includes a single element or multiple antenna elements (such as multiple antenna elements included in a MIMO antenna) and is used for the RRH 860 to transmit and receive a wireless signal. As shown in FIG. 18, the eNB 830 may include multiple antennas 840. For example, the multiple antennas 840 may be compatible with multiple frequency bands used by the eNB 830. Although FIG. 18 shows an example in which the eNB 830 includes multiple antennas 840, the eNB 830 may also include a single antenna 840.

The base station equipment 850 includes a controller 851, a memory 852, a network interface 853, a radio communication interface 855, and a connection interface 857. The controller 851, the memory 852, and the network interface 853 are the same as the controller 821, the memory 822, and the network interface 823 as described with reference to FIG. 17.

The radio communication interface 855 supports any cellular communication scheme (such as LTE and LTE-Advanced), and provides wireless communications to a terminal located in a sector corresponding to the RRH 860 via the RRH 860 and the antenna 840. The radio communication interface 855 may generally include, for example, a BB processor 856. The BB processor 856 is the same as the BB processor 826 as described with reference to FIG. 17 except that the BB processor 856 is connected to the RF circuit 864 of the RRH 860 via the connection interface 857. As shown in FIG. 18, the radio communication interface 855 may include multiple BB processors 856. For example, the multiple BB processors 856 may be compatible with multiple frequency bands used by the eNB 830. Although FIG. 18 shows an example in which the radio communication interface 855 includes multiple BB processors 856, the radio communication interface 855 may also include a single BB processor 856.

The connection interface 857 is an interface for connecting the base station equipment 850 (radio communication interface 855) to the RRH 860. The connection interface 857 may also be a communication module for communication in the above-mentioned high-speed line that connects the RRH 860 to the base station equipment 850 (radio communication interface 855).

The RRH 860 includes a connection interface 861 and a radio communication interface 863.

The connection interface 861 is an interface for connecting the RRH 860 (radio communication interface 863) to the base station equipment 850. The connection interface 861 may also be a communication module for communication in the above-mentioned high-speed line.

The radio communication interface 863 transfers and receives wireless signals via the antenna 840. The radio communication interface 863 may generally include, for example, an RF circuit 864. The RF circuit 864 may include, for example, a mixer, a filter, and an amplifier, and transfer and receive wireless signals via the antenna 840. As shown in FIG. 18, the radio communication interface 863 may include multiple RF circuits 864. For example, the multiple RF circuits 864 may support multiple antenna elements. Although FIG. 18 shows an example in which the radio communication interface 863 includes multiple RF circuits 864, the radio communication interface 863 may also include a single RF circuit 864.

In the eNB 830 shown in FIG. 18, the transceiver of the management electronic device 100 may be implemented by the radio communication interface 855. At least a part of the function may also be implemented by the controller 851. For example, the controller 851 may select a new management electronic device by performing the functions of the obtaining unit 101, the receiving unit 103, the determining unit 105 and the selecting unit 107.

In the eNB 830 shown in FIG. 18, the transceiver of the electronic device 1400 may be implemented by the radio communication interface 855. At least a part of the function may also be implemented by the controller 851. For example, the controller 851 may transmit the interference suffered by the electronic device 1400 to the management electronic device and receive information on the new management electronic device by performing the functions of the transmitting unit 1401 and the information receiving unit 1403.

The basic principle of the present disclosure has been described above in conjunction with specific embodiments. However, it should be pointed out that, for those skilled in the art, it could be understood that all or any step or component of the methods and devices of the present disclosure may be implemented in any computing device (including processors, storage media, etc.) or network of computing devices in the form of hardware, firmware, software, or a combination thereof. This can be achieved by those skilled in the art utilizing their basic circuit design knowledge or basic programming skills after reading the description of the present disclosure.

Moreover, the present disclosure also proposes a program product storing a machine-readable instruction code that, when read and executed by a machine, can execute the above-mentioned methods according to the embodiments of the present invention.

Accordingly, a storage medium for carrying the above-mentioned program product storing a machine-readable instruction code is also included in the disclosure of the present invention. The storage medium includes, but is not limited to, a floppy disk, an optical disk, a magneto-optical disk, a memory card, a memory stick, etc.

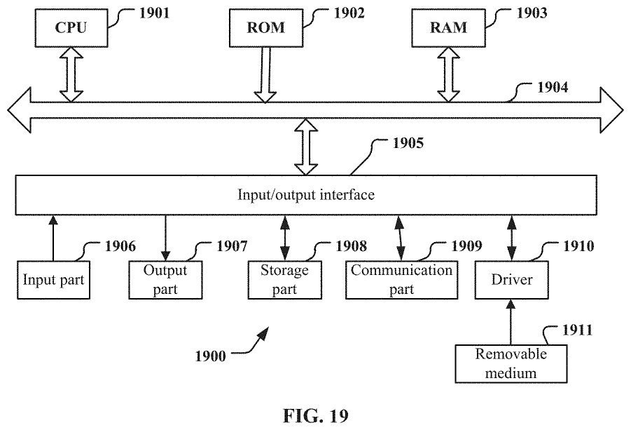

In a case where the present disclosure is implemented by software or firmware, a program constituting the software is installed from a storage medium or a network to a computer with a dedicated hardware structure (e.g., a general-purpose computer 1900 as shown in FIG. 19). The computer, when installed with various programs, can execute various functions and the like.

In FIG. 19, a central processing unit (CPU) 1901 executes various processing in accordance with a program stored in a read only memory (ROM) 1902 or a program loaded from a storage part 1908 to a random access memory (RAM) 1903. In the RAM 1903, data required when the CPU 1901 executes various processing and the like is also stored as needed. The CPU 1901, the ROM 1902, and the RAM 1903 are connected to each other via a bus 1904. The input/output interface 1905 is also connected to the bus 1904.

The following components are connected to the input/output interface 1905; an input part 1906 (including a keyboard, a mouse, etc.), an output part 1907 (including a display, such as a cathode ray tube (CRT), a liquid crystal display (LCD), etc., and a speaker, etc.), a storage part 1908 (including a hard disk, etc.), and a communication part 1909 (including a network interface card such as an LAN card, a modem, etc.). The communication part 1909 executes communication processing via a network such as the Internet. The driver 1910 may also be connected to the input/output interface 1905, as needed. A removable medium 1911 such as a magnetic disk, an optical disk, a magneto-optical disk, a semiconductor memory and the like is installed on the driver 1910 as needed, so that a computer program read out therefrom is installed into the storage part 1908 as needed.

In a case where the above-mentioned series of processing is implemented by software, a program constituting the software is installed from a network such as the Internet or a storage medium such as the removable medium 1911.

Those skilled in the art should understand that, this storage medium is not limited to the removable medium 1911 as shown in FIG. 19 which has a program stored therein and which is distributed separately from an apparatus to provide the program to users. Examples of the removable media 1911 include magnetic disks (including a floppy disk (registered trademark)), an optical disk (including a compact disk read-only memory (CD-ROM) and a digital versatile disk (DVD)), a magneto-optical disk (including a mini disk (MD) (registered trademark)), and a semiconductor memory. Alternatively, the storage medium may be the ROM 1902, a hard disk included in the storage part 1908, etc., which have programs stored therein and which are distributed concurrently with the apparatus including them to users.

It should also be pointed out that in the devices, methods and systems of the present disclosure, components or steps may be decomposed and/or recombined. These decompositions and/or recombination should be regarded as equivalent solutions of the present disclosure. Moreover, the steps of executing the above-mentioned series of processing may naturally be executed in chronological order in the order as described, but do not necessarily need to be executed in chronological order. Some steps may be executed in parallel or independently of each other.

Finally, it should be noted that, the terms “include”, “comprise” or any other variants thereof are intended to cover non-exclusive inclusion, so that a process, method, article or apparatus that includes a series of elements not only includes those elements, but also includes other elements that are not explicitly listed, or also includes elements inherent to such a process, method, article, or apparatus. Furthermore, in the absence of more restrictions, an element defined by a sentence “including one . . . ” does not exclude the existence of other identical elements in a process, method, article, or apparatus that includes the element.

This technology can also be implemented as follows.

(1). A management electronic device for wireless communications, where the management electronic device has a management right in an Nth round of spectrum transactions, and N is a positive integer greater than or equal to 1, the management electronic device including:

a processing circuit, configured to:
obtain an interference suffered by the management electronic device when a spectrum acquiring electronic device in the Nth round of spectrum transactions uses the transacted spectrums;
receive interference suffered by other electronic devices when the spectrum acquiring electronic device uses the transacted spectrums, which is determined by the other electronic devices related to spectrum transactions;
determine competition right parameters of the management electronic device and the other electronic devices respectively, where the competition right parameters characterize a degree of trust and competitiveness for competing a management right in an (N+1)th round of spectrum transactions of the electronic device; and
select a new management electronic device based on at least one of the interference and the competition right parameters, where the new management electronic device rather than the management electronic device has the management right in the (N+1)th round of spectrum transactions.

(2). The management electronic device according to (1), where the processing circuit is configured to:

calculate, in a case of determining that the spectrum acquiring electronic device is located in a protection area of the management electronic device, an interference to the management electronic device when the spectrum acquiring electronic device uses the transacted spectrum, where the protection area is determined based on spectrum transaction information related to the Nth round of spectrum transactions.

(3). The management electronic device according to (2), where the protection area is a circular area centered at the management electronic device, and a radius of the circular area is calculated based on transmission power of the spectrum acquiring electronic device and/or a spectrum providing electronic device contained in the spectrum transaction information and a predetermined interference threshold that is set for the management electronic device.

(4). The management electronic device according to (2) or (3), where the processing circuit is configured to calculate the interference based on position information of the spectrum acquiring electronic device, position information of the management electronic device and transmission power information of the spectrum acquiring electronic devices.

(5). The management electronic device according to (1), where the processing circuit is configured to neither provide services for a user equipment within a coverage area of the management electronic device nor receive a signal from the user equipment for a predetermined period of time, and determine a received signal measured within the predetermined period of time as the interference.

(6). The management electronic device according to any one of (1) to (5), where the processing circuit is configured to, for each of the management electronic device and the other electronic devices, calculate a competing right parameter of the electronic device based on at least one of the total amount of spectrum held by the electronic device, a total time period that the electronic device held the spectrum, the total amount of currency held by the electronic device to acquire the spectrum, and a time period that the electronic device held the currency, where

a great total amount of the spectrum held by the electronic device and/or a long time period that the electronic device holds the spectrum correspond to a great competition right parameter of the electronic device; and

a great total amount of currency held by the electronic device and/or a long time period that the electronic device holds the currency correspond to a great competition right parameter of the electronic device.

(7). The management electronic device according to any one of (1) to (6), where

the processing circuit is configured to determine an electronic device having a competition right parameter greater than a predetermined competition right parameter threshold among the management electronic device and the other electronic devices as an electronic device having a competition right; and

the processing circuit is configured to select, in the presence of at least one second electronic device that is more interfered compared to a first electronic device among the electronic devices with the competition right and a difference between the interferences between the at least one second electronic device is less than a predetermined difference threshold, the electronic device with the largest competition right parameter among the at least one second electronic device as the new management electronic device.

(8). The management electronic device according to any one of (1) to (7), where the processing circuit is configured to notify the other electronic devices of a result of selecting the new management electronic device, and send the interference suffered by the management electronic device and the interference suffered by the other electronic devices to the new management electronic device,

where the new management electronic device records the interference suffered by the management electronic device and the interference suffered by other electronic devices in spectrum transaction information about the (N+1)th round of spectrum transactions.

(9). The management electronic device according to any one of (1) to (8), where the management electronic device and the other electronic devices each serves as a subject of a decentralized spectrum management system, and the management right is included in the billing right in the decentralized spectrum management system.

(10). The management electronic device according to (9), where the decentralized spectrum management system includes a blockchain.

(11). The management electronic device according to (10), where the new management electronic device records the interference suffered by the management electronic device and the interference suffered by the other electronic devices in a block header of a block including spectrum transaction information of the (N+1)th round of spectrum transactions.

(12). An electronic device for wireless communications, including:

a processing circuit configured to:
send an interference, which is suffered by the electronic device when a spectrum acquiring electronic device in an Nth round of spectrum transactions uses a transacted spectrum, to a management electronic device that has a management right in the Nth round of spectrum transactions, where N is a positive integer greater than or equal to 1; and
receive, from the management electronic device, information on a new management electronic device that has the management right in an (N+1)th round of spectrum transactions.

(13). The electronic device according to (12), where the processing circuit is configured to calculate, when it is determined that the spectrum acquiring electronic device is located in a protection area of the electronic device, the interference suffered by the electronic device when the spectrum acquiring electronic device uses the transacted spectrum, where the protection area is determined based on spectrum transaction information related to the Nth round of spectrum transactions.

(14). The electronic device according to (13), where the protection area is a circular area centered on the electronic device, and a radius of the circular area is calculated based on transmission power of the spectrum acquiring electronic device and/or a spectrum providing electronic device included in the spectrum transaction information as well as a predetermined interference threshold set for the management electronic device.

(15). The electronic device according to (13) or (14), where the processing circuit is configured to calculate the interference based on location information of the spectrum acquiring electronic device, location information of the electronic device, and transmission power information of the spectrum acquiring electronic device.

(16). The electronic device according to (12), where the processing circuit is configured to neither provide services for user equipment within a coverage area of the electronic device nor receive a signal from the user equipment for a predetermined period of time, and determine a received signal measured within the predetermined period of time as interference.

(17). The electronic device according to any one of (12) to (16), where the electronic device and the management electronic device each serves as a subject of a decentralized spectrum management system, and the management right is included in the billing right in the decentralized spectrum management system.

(18). The electronic device according to (17), where the decentralized spectrum management system includes a blockchain.

(19). A method for wireless communications, including:

obtaining an interference suffered by a management electronic device when a spectrum acquiring electronic device in an Nth round of spectrum transactions uses a transacted spectrum, where the management electronic device has a management right in the Nth round of spectrum transactions, and N is a positive integer greater than or equal to 1;

receiving an interference suffered by other electronic device when the spectrum acquiring electronic device use the transacted spectrum, which is determined by the other electronic device related to spectrum transactions;

determining competition right parameters of the management electronic device and the other electronic device respectively, where the competition right parameters characterize a degree of trust and competitiveness for competing a management right in an (N+1)th round of spectrum transactions of the electronic device; and

selecting a new management electronic device based on at least one of the interference and the competition right parameters, where the new management electronic device rather than the management electronic device has the management right in the (N+1)th round of spectrum transactions.

(20). A method for wireless communications, including:

sending an interference, which is suffered by an electronic device when a spectrum acquiring electronic device in an Nth round of spectrum transactions uses a transacted spectrum, to a management electronic device that has a management right in the Nth round of spectrum transactions, where N is a positive integer greater than or equal to 1; and

receiving, from the management electronic device, information on a new management electronic device that has a management right in an (N+1)th round of spectrum transactions.

(21). A computer-readable medium having stored thereon computer executable instructions which, when being executed, execute the method for wireless communications according to (19) or (20).

22. A base station for wireless communications, including the management electronic device according to any one of (1) to (11).

(23). A base station for wireless communications, including the electronic device according to any one of (12) to (18).

Although the embodiments of the present disclosure have been described above in detail in conjunction with the accompanying drawings, it should be appreciated that, the above-described embodiments are only used to illustrate the present invention and do not constitute a limitation to the present invention. For those skilled in the art, various modifications and changes may be made to the above-mentioned embodiments without departing from the essence and scope of the present invention. Therefore, the scope of the present invention is defined only by the appended claims and equivalent meanings thereof.

1. A management electronic device for wireless communications, wherein the management electronic device has a management right in an Nth round of spectrum transactions, and N is a positive integer greater than or equal to 1, the management electronic device comprising:
a processing circuit, configured to:
obtain an interference suffered by the management electronic device when a spectrum acquiring electronic device in the Nth round of spectrum transactions uses a transacted spectrum;
receive interference suffered by other electronic devices when the spectrum acquiring electronic device uses the transacted spectrums, which is determined by the other electronic devices related to spectrum transactions;
determine competition right parameters of the management electronic device and the other electronic devices respectively, wherein the competition right parameters characterize a degree of trust and competitiveness for competing a management right in an (N+1)th round of spectrum transactions of the electronic device; and
select a new management electronic device based on at least one of the interference and the competition right parameters, wherein the new management electronic device rather than the management electronic device has the management right in the (N+1)th round of spectrum transactions.

2. The management electronic device according to claim 1, wherein the processing circuit is configured to:
calculate, in a case of determining that the spectrum acquiring electronic device is located in a protection area of the management electronic device, an interference to the management electronic device when the spectrum acquiring electronic device uses the transacted spectrum, wherein the protection area is determined based on spectrum transaction information related to the Nth round of spectrum transactions.

3. The management electronic device according to claim 2, wherein the protection area is a circular area centered at the management electronic device, and a radius of the circular area is calculated based on transmission power of the spectrum acquiring electronic device and/or a spectrum providing electronic device contained in the spectrum transaction information and a predetermined interference threshold that is set for the management electronic device.

4. The management electronic device according to claim 2, wherein the processing circuit is configured to calculate the interference based on position information of the spectrum acquiring electronic device, position information of the management electronic device and transmission power information of the spectrum acquiring electronic devices.

5. The management electronic device according to claim 1, wherein the processing circuit is configured to neither provide services for a user equipment within a coverage area of the management electronic device nor receive a signal from the user equipment for a predetermined period of time, and determine a received signal measured within the predetermined period of time as the interference.

6. The management electronic device according to claim 1, wherein the processing circuit is configured to, for each of the management electronic device and the other electronic devices, calculate a competing right parameter of the electronic device based on at least one of the total amount of spectrum held by the electronic device, a total time period that the electronic device held the spectrum, the total amount of currency held by the electronic device to acquire the spectrum, and a time period that the electronic device held the currency, wherein
a great total amount of the spectrum held by the electronic device and/or a long time period that the electronic device holds the spectrum correspond to a great competition right parameter of the electronic device; and
a great total amount of currency held by the electronic device and/or a long time period that the electronic device holds the currency correspond to a great competition right parameter of the electronic device.

7. The management electronic device according to claim 1, wherein
the processing circuit is configured to determine an electronic device having a competition right parameter greater than a predetermined competition right parameter threshold among the management electronic device and the other electronic devices as an electronic device having a competition right; and
the processing circuit is configured to select, in the presence of at least one second electronic device that is more interfered compared to a first electronic device among the electronic devices with the competition right and a difference between the interferences between the at least one second electronic device is less than a predetermined difference threshold, the electronic device with the largest competition right parameter among the at least one second electronic device as the new management electronic device.

8. The management electronic device according to claim 1,
wherein the processing circuit is configured to notify the other electronic devices of a result of selecting the new management electronic device, and send the interference suffered by the management electronic device and the interference suffered by the other electronic devices to the new management electronic device,
wherein the new management electronic device records the interference suffered by the management electronic device and the interference suffered by other electronic devices in spectrum transaction information about the (N+1)th round of spectrum transactions.

9. The management electronic device according to claim 1, wherein the management electronic device and the other electronic devices each serves as a subject of a decentralized spectrum management system, and the management right is included in the billing right in the decentralized spectrum management system.

10. The management electronic device according to claim 9, wherein the decentralized spectrum management system comprises a blockchain.

11. The management electronic device according to claim 10, wherein the new management electronic device records the interference suffered by the management electronic device and the interference suffered by the other electronic devices in a block header of a block comprising spectrum transaction information of the (N+1)th round of spectrum transactions.

12. An electronic device for wireless communications, comprising:
a processing circuit configured to:
send an interference, which is suffered by the electronic device when a spectrum acquiring electronic device in an Nth round of spectrum transactions uses a transacted spectrum, to a management electronic device that has a management right in the Nth round of spectrum transactions, wherein N is a positive integer greater than or equal to 1; and
receive, from the management electronic device, information on a new management electronic device that has the management right in an (N+1)th round of spectrum transactions.

13. The electronic device according to claim 12, wherein the processing circuit is configured to calculate, when it is determined that the spectrum acquiring electronic device is located in a protection area of the electronic device, the interference suffered by the electronic device when the spectrum acquiring electronic device uses the transacted spectrum, wherein the protection area is determined based on spectrum transaction information related to the Nth round of spectrum transactions.

14. The electronic device according to claim 13, wherein the protection area is a circular area centered on the electronic device, and a radius of the circular area is calculated based on transmission power of the spectrum acquiring electronic device and/or a spectrum providing electronic device as well as a predetermined interference threshold set for the management electronic device that are included in the spectrum transaction information.

15. The electronic device according to claim 13, wherein the processing circuit is configured to calculate the interference based on location information of the spectrum acquiring electronic device, location information of the electronic device, and transmission power information of the spectrum acquiring electronic device.

16. The electronic device according to claim 12, wherein the processing circuit is configured to neither provide services for user equipment within a coverage area of the electronic device nor receive a signal from the user equipment for a predetermined period of time, and determine a received signal measured within the predetermined period of time as interference.

17. The electronic device according to claim 12, wherein the electronic device and the management electronic device each serves as a subject of a decentralized spectrum management system, and the management right is included in the billing right in the decentralized spectrum management system.

18. The electronic device according to claim 17, wherein the decentralized spectrum management system comprises a blockchain.

19.-21. (canceled)

22. A base station for wireless communications, comprising the management electronic device according to claim 1.

23. A base station for wireless communications, comprising the electronic device according to claim 12.
